(19) United States
(12) Patent Application Publication
(10) Pub. No.: US 2026/0362399 A1
(43) Pub. Date: Nov. 12, 2026

(54) TIME DOMAIN DETERMINATION METHOD AND APPARATUS

(71) Applicant: Beijing Xiaomi Mobile Software Co., Ltd., Beijing (CN)

(72) Inventor: Shengxiang GUO, Beijing (CN)

(21) Appl. No.: 19/120,969

(22) PCT Filed: Oct. 20, 2022
(86) PCT No.: PCT/CN2022/126508

§ 371 Date: Apr. 14, 2025

(51) Int. Cl. H04W 72/0446; H04W 52/02

(52) U.S. Cl. CPC H04W 72/0446; H04W 52/0235

(57) ABSTRACT

A method for time domain determination is performed by a terminal, and includes: determining a first time domain position, wherein a power saving response signal is sent by the terminal at the first time domain position, and the power saving response signal indicates whether at least one primary receiver or at least one primary transceiver of the terminal is woken up.

### CROSS REFERENCE TO RELATED APPLICATIONS

The present application is a U.S. National Stage of International Application No. PCT/CN2022/126508, filed on Oct. 20, 2022, the content of which is incorporated herein by reference in its entirety.

### TECHNICAL FIELD

The present disclosure relates to the field of mobile communications, and in particular, to a method for time domain determination, and an apparatus.

### BACKGROUND

In a mobile communication system, it may be triggered, by introducing a power saving signal, whether the terminal needs to start normal processing of uplink data and downlink data. the access network device may trigger the terminal to process the uplink data and the downlink data by sending a power saving signal to the terminal. If the access network device does not trigger the terminal to process the uplink data and the downlink data by using the power saving signal, the terminal is in a dormant state, thus saving the overhead of the terminal.

### SUMMARY

According to a first aspect of the present disclosure, there is provided a method for time domain determination, where the method is performed by a terminal, and the method includes:
determining a first time domain position, where a power saving response signal is sent by the terminal at the first time domain position, and the power saving response signal indicates whether at least one primary receiver or at least one primary transceiver of the terminal is woken up.

According to a second aspect of the present disclosure, there is provided a method for time domain determination, where the method is performed by an access network device, and the method includes:
determining a first time domain position, where the a power saving response signal is sent by the terminal at first time domain position, and the power saving response signal indicates whether at least one primary receiver or at least one primary transceiver of the terminal is woken up.

According to another aspect of the present disclosure, there is provided a terminal, including: a processor; a transceiver, connected to the processor; and a memory, configured to store an executable instruction for the processor, where the processor is configured to load and execute the executable instruction to implement the method for time domain determination according to the first aspect.

According to another aspect of the present disclosure, there is provided an access network device, including: a processor; a transceiver, connected to the processor; and a memory, configured to store an executable instruction for the processor, where the processor is configured to load and execute the executable instruction to implement the method for time domain determination according to the second aspect.

According to another aspect of the present disclosure, there is provided a non-transitory computer-readable storage medium, where executable program code is stored in the non-transitory computer-readable storage medium, and the executable program code is loaded and executed by a processor to implement the method for time domain determination according to the first aspect or the second aspect.

### BRIEF DESCRIPTION OF THE DRAWINGS

The accompanying drawings of the present disclosure are briefly described below. Obviously, the accompanying drawings in the following description are merely example embodiments of the present disclosure.

FIG. 1 is a block diagram of a communication system provided according to some embodiments of the present disclosure;

FIG. 2 is a flowchart of a method for time domain determination provided according to some embodiments of the present disclosure;

FIG. 3 is a block diagram of an apparatus for time domain determination provided according to some embodiments of the present disclosure;

FIG. 4 is a block diagram of another apparatus for time domain determination provided according to some embodiments of the present disclosure;

FIG. 5 is a block diagram of an apparatus for time domain determination provided according to some embodiments of the present disclosure;

FIG. 6 is a block diagram of another apparatus for time domain determination provided according to some embodiments of the present disclosure;

FIG. 7 is a schematic structural diagram of a communication device provided according to some embodiments of the present disclosure.

### DETAILED DESCRIPTION

Example embodiments will be described in detail here, examples of which are illustrated in the accompanying drawings. The following description refers to the accompanying drawings in which the same numbers in different drawings represent the same or similar elements unless otherwise represented. The implementations described in the following example embodiments do not represent all implementations consistent with the present disclosure. Instead, they are merely examples of apparatuses and methods consistent with some aspects of the present disclosure as detailed in the appended claims.

The terms used in the present disclosure are for the purpose of describing particular embodiments only and are not intended to limit the present disclosure. As used in the present disclosure and the appended claims, the singular forms “a” “ the ”and“ said ” are intended to include the plural forms as well, unless the context clearly indicates other meanings. It should also be understood that the term “and/or” as used here refers to and includes any or all possible combinations of one or more associated listed items.

It should be understood that, although the terms “first”, “second”, “third”, or the like, may be used in the present disclosure to describe various information, these information should not be limited to these terms. These terms are only used to distinguish the same type of information from each other. For example, without departing from the scope of the present disclosure, the first information may also be referred to as second information, and similarly, the second information may also be referred to as first information. Depending on the context, for example, the word “if” used here may be interpreted as “ at the time . . . ”or“ when . . . ”or“ in response to determining . . . ”.

It should be noted that the information (including but not limited to user equipment information, user personal information, etc.), data (including but not limited to data for analysis, stored data, displayed data, etc.) and signals involved in the present disclosure are authorized by a user or fully authorized by various parties. Collection, usage and processing of related data need to comply with relevant laws and regulations and standards of related countries and regions.

Firstly, terms involved in the present disclosure are described.

Power saving signal: The primary receiver or the primary transceiver of the terminal may be in a sleep state when there is no data to be processed, and the access network device may wake up the primary receiver or the primary transceiver by using the power saving signal, so that resources may be saved in the terminal when there is no data to be processed. In some embodiments, the power saving signal is a wake up signal (WUS), a low power wake up signal (LP WUS), a paging early indication (PEI) signal, a DCI for power saving (DCP) signal, or other signals, which is not limited in the embodiments of the present disclosure.

Primary receiver. If the terminal needs to receive the downlink data sent by the access network device, the downlink data may be received by using the primary receiver, and the downlink data may further be processed by using the primary receiver. It should be noted that the terminal further includes a corresponding secondary receiver, and the secondary receiver may receive the power saving signal sent by the access network device.

Primary transceiver. If the terminal needs to receive the downlink data sent by the access network device, or the terminal needs to send the uplink data to the access network device, the downlink data sent by the access network device may be received by using the primary transceiver, or the uplink data may be sent to the access network device by using the primary transceiver. It should be noted that the terminal further includes a corresponding secondary transceiver, and the secondary transceiver may receive the power saving signal sent by the access network device.

Secondly, the application scenario of the present disclosure is described:

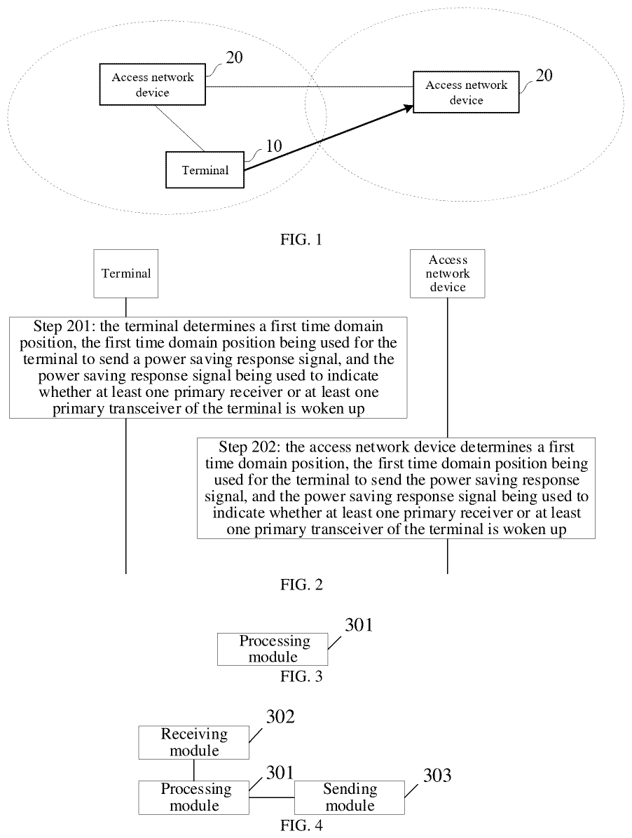

FIG. 1 is a block diagram of a communication system provided according to some embodiments of the present disclosure, and the communication system may include a terminal 10 and an access network device 20.

Generally, there are a plurality of terminals 10, and one or more terminals 10 may be distributed in a cell managed by each access network device 20. The terminal 10 may include various handheld devices with wireless communication capabilities, vehicle-mounted devices, wearable devices, computing devices, or other processing devices connected to a wireless modem, and various forms of user equipment (UE), mobile stations (MS), or the like. For ease of description, in the embodiments of the present disclosure, the foregoing devices are collectively referred to as a terminal.

The access network device 20 is an apparatus deployed in an access network to provide a wireless communication function for the terminal 10. For ease of description, in the embodiments of the present disclosure, the foregoing apparatus that provides a wireless communication function for the terminal 10 is collectively referred to as an access network device. A connection between the access network device 20 and the terminal 10 may be established through an air interface, so as to perform communication through the connection, which includes signaling and data interaction. There may be a plurality of access network devices 20, and communication may also be performed between two adjacent access network devices 20 in a wired or wireless manner. The terminal 10 may send beam reports to different access network devices 20, that is, the terminal 10 may establish a connection with different access network devices 20.

The access network device 20 may include various forms of macro base stations, micro base stations, relay stations, access points, or the like. In systems using different radio access technologies, the names of the devices with a function of an access network device may be different. For example, in a 5G New Radio (NR) system, the name may be referred to as a gNodeB or a gNB. With the evolution of communication technologies, the name of “access network device” may change.

The “5G NR system” in the embodiments of the present disclosure may also be referred to as a 5G system or an NR system, but those skilled in the art may understand the meaning of the 5G system or the NR system. The technical solutions described in the embodiments of the present disclosure may be applied to a 5G NR system, or may be applied to a subsequent evolution system of the 5G NR system.

How to transmit a power saving signal between the terminal and the access network device becomes an urgent problem to be solved.

FIG. 2 is a flowchart of a method for time domain determination provided according to some embodiments of the present disclosure, which may be applied to the terminal and the access network device shown in FIG. 1, and the method includes at least some of the following content.

In step 201, the terminal determines a first time domain position, where the first time domain position is used for the terminal to send a power saving response signal, and the power saving response signal is used to indicate whether at least one primary receiver or at least one primary transceiver of the terminal is woken up.

In step 202, the access network device determines the first time domain position, where the first time domain position is used for the terminal to send a power saving response signal, and the power saving response signal is used to indicate whether at least one primary receiver or at least one primary transceiver of the terminal is woken up.

In some embodiments, the first time domain position is a position where the terminal sends a power saving response signal in a time domain dimension. The first time domain position may also be understood as a moment when the terminal sends the power saving response signal. The power saving response signal is used to indicate whether the at least one primary receiver or the at least one primary transceiver of the terminal is woken up. That is, the terminal may wake up its own primary receiver or primary transceiver, and the terminal may switch the primary receiver or the primary transceiver from a sleep state to a wake-up state. For the terminal, the terminal may report, by using the power saving response signal, the state whether its own primary receiver or primary transceiver is woken up to the access network device.

In some embodiments, the first time domain position is the m-th time domain unit, and m is a positive integer. In some embodiments, the time domain unit may be represented by using a slot, or may be represented by using a symbol, which is not limited in the embodiments of the present disclosure.

For example, if the time domain unit is represented by using a slot, and one time domain unit includes one slot, the first time domain position may be the first slot, the second slot, the third slot, or another slot. For another example, if the time domain unit is represented by using a symbol, and one time domain unit includes four symbols, the first time domain position may be symbols from the first symbol to the fourth symbol, symbols from the fifth symbol to the eighth symbol, or symbols at other positions, which is not limited in the embodiments of the present disclosure.

In the embodiments of the present disclosure, both the terminal and the access network device may determine the first time domain position, so that the terminal may send the power saving response signal based on the first time domain position. Then the terminal may report whether the at least one primary receiver or the at least one primary transceiver of the terminal is woken up, so that the access network device determines, based on the power saving response signal, whether to schedule the transmission resource for the terminal.

Furthermore, the terminal determines the first time domain position, and then sends the power saving response signal at the first time domain position, so that the access network device may receive the power saving response signal sent by the terminal based on the first time domain position.

In some embodiments, the access network device sends a power saving signal to the terminal, so as to wake up the primary receiver or the primary transceiver of the terminal. The terminal, in response to the power saving signal, sends a power saving response signal to the access network device, to inform whether the primary receiver or the primary transceiver of the terminal is woken up.

In some embodiments, the terminal is configured with a primary receiver, or two primary receivers, or four primary receivers, which is not limited in the embodiments of the present disclosure. In some embodiments, the terminal is correspondingly configured with a primary transceiver, or two primary transceivers, or four primary transceivers.

In some embodiments, the power saving response signal is also referred to as a low-power wake-up response signal.

It should be noted that, in the embodiments of the present disclosure, the steps performed by the terminal may separately form a new embodiment, and the steps performed by the access network device may also separately form a new embodiment.

The present disclosure provides a solution for determining a fixed time domain position for sending a power saving response signal by a terminal, to ensure that the terminal sends the power saving response signal at the fixed time domain position, and the access network device receives the power saving response signal at the fixed time domain position, thus improving accuracy of receiving the power saving response signal by the access network device, and ensuring communication reliability.

It should be noted that the foregoing embodiment is described by using an example in which the terminal sends the power saving response signal at the first time domain position. Before the terminal sends the power saving response signal, the access network device may further send a first power saving signal, and the terminal receives the first power saving signal. The first power saving signal is used to indicate whether the terminal wakes up at least one primary receiver or at least one primary transceiver. After performing an operation according to the first power saving signal, the terminal sends the power saving response signal in response to the first power saving signal.

In the embodiments of the present disclosure, the terminal determines, based on the received power saving signal, whether to wake up the primary receiver or the primary transceiver, so that the terminal determines whether to wake up the primary receiver or the primary transceiver according to the power saving signal, to improve communication reliability.

In addition, after a fourth duration, the access network device sends a second power saving signal in a case of determining that the power saving response signal is not received, and the terminal receives the second power saving signal. Steps 201 to 202 are performed again. In some embodiments, there is no need to perform steps 201 to 202 again.

In some embodiments, the fourth duration is a time absolute value. For example, the fourth duration is 3 ms, 4 ms, or another value. In some embodiments, the fourth duration is represented by using a time domain identifier. For example, the fourth duration is represented by using a slot, or is represented by using a symbol.

In some embodiments, the access network device sends the first power saving signal, and sends the second power saving signal in a case of determining that the power saving response signal is not received within the fourth duration.

It should be noted that, if the terminal and the access network device do not perform steps 201 to 202, a third power saving signal may be sent again, and so on.

In the embodiment shown in FIG. 2, it is described that the terminal may determine the first time domain position. How the terminal determines the first time domain position is described below.

In some embodiments, the first time domain position is configured and determined by the access network device.

In the embodiments of the present disclosure, the access network device sends configuration information, where the configuration information is used to configure the first time domain position. The terminal receives the configuration information, and may determine the indicated first time domain position based on the configuration information.

In some embodiments, the configuration information is notified to the terminal by the access network device by using dynamic signaling, semi-static signaling, or other signaling. For example, the configuration information is sent by using RRC (Radio Resource Control), Downlink Control Information (DCI), or a MAC CE (Media Access Control Control Element).

In some embodiments, the first time domain position includes at least one of the following cases.

(1) The first time domain position is a time domain position where an uplink resource is present after the access network device sends the first power saving signal.

In some embodiments, the first power saving signal is used to wake up at least one primary receiver or at least one primary transceiver of the terminal. If the access network device needs to wake up at least one primary receiver or at least one primary transceiver of the terminal, the access network device sends a first power saving signal, and the terminal may also receive the first power saving signal. In addition, the terminal may further send a power saving response signal at a time domain position after receiving the first power saving signal. The first time domain position for sending the first power saving signal is a time domain position where the uplink resource is present after the access network device sends the first power saving signal.

(2) The first time domain position is a time domain position where an uplink resource is present after a first duration from a moment that the access network device sends the first power saving signal.

In some embodiments, the first power saving signal is used to wake up at least one primary receiver or at least one primary transceiver of the terminal. If the access network device needs to wake up at least one primary receiver or at least one primary transceiver of the terminal, the access network device sends the first power saving signal, and the terminal may also receive the first power saving signal. The terminal may further send a power saving response signal at a time domain position after the first duration from a moment that the terminal receives the first power saving signal. The first time domain position for sending the first power saving signal is a time domain position where the uplink resource is present after the first time duration from a moment that the access network device sends the first power saving signal.

In some embodiments, the first duration is agreed by a communication protocol, configured by an access network device, or configured in another manner, which is not limited in the embodiments of the present disclosure.

In some embodiments, the first duration is a time absolute value. For example, the first duration is 3 ms, 4 ms, or another value. In some embodiments, the first duration is represented by using a time domain identifier. For example, the first duration is represented by using a slot, or is represented by using a symbol.

(3) The first time domain position is a time domain position configured with the power saving response signal.

In the embodiments of the present disclosure, it may be determined whether the time domain position of the terminal is configured with the power saving response signal. If the time domain position is configured with the power saving response signal, it indicates that the time domain position is used to transmit the power saving response signal, and indicates that the time domain position configured with the power saving response signal is the first time domain position.

(4) The first time domain position is a time domain position configured with the power saving response signal after a first duration from a moment that the access network device sends the first power saving signal.

The first power saving signal is used to wake up at least one primary receiver or at least one primary transceiver of the terminal. If the access network device needs to wake up at least one primary receiver or at least one primary transceiver of the terminal, the access network device sends the first' power saving signal, and the terminal may also receive the first power saving signal. The terminal may further send a power saving response signal at the time domain position configured with the power saving response signal after the first duration from a moment that the terminal receives the first power saving signal. The first time domain position for sending the first power saving signal is the time domain position configured with the power saving response signal after the first duration from a moment that the access network device sends the first power saving signal.

In the solution provided in the embodiments of the present disclosure, the terminal may determine the first time domain position, so as to send the power saving response signal according to the determined first time domain position, to ensure that the access network device receives the power saving response signal at the fixed time domain position, thus improving the accuracy of receiving the power saving response signal by the access network device, and ensuring communication reliability.

In the embodiment shown in FIG. 2, it is described that the terminal sends a power saving response signal. In another embodiment, the terminal may further send the power saving response signal in different manners.

In some embodiments, the power saving response signal is sent once or periodically.

In the embodiments of the present disclosure, if the power saving response signal is sent once, it indicates that the terminal sends the power saving response signal once at the first time domain position. If the power saving response signal is sent periodically, it indicates that the terminal sends the power saving response signal more than one time at the first time domain position.

In some embodiments, the terminal determines a first number of first time domain positions based on a time domain offset, and then sends the first number of power saving response signals based on the first number of first time domain positions.

In the embodiments of the present disclosure, the time domain offset is used to indicate a start position of the first time domain position. The start position of the first time domain position is a position with a time domain offset relative to the time domain position where the terminal receives the power saving signal.

For example, the terminal is configured with the time domain position 1, the time domain position 2 and the time domain position 3. If the terminal receives the power saving signal at the time domain position 1, and the time domain offset is 1, the terminal determines that the time domain position 2 is the starting position. In addition, if the first number is 2, it indicates that the time domain position 2 and the time domain position 3 are the first time domain position, and the terminal sends the power saving response signal at the time domain position 2 and the time domain position 3.

For another example, taking the first time domain position being a slot as an example, if the time domain offset is 2 and the first number is 5, when it is determined that the terminal receives the power saving signal at the slot 1, it is determined that the first time domain position is slot 3, slot 4, slot 5, slot 6, and slot 7.

It should be noted that, in the embodiments of the present disclosure, it is described by using an example in which the terminal sends the power saving response signal. After sending the power saving response signal, the terminal may further determine whether to control at least one primary receiver or at least one primary transceiver to be in a sleep state.

In some embodiments, after sending the first number of power saving response signals and determining that scheduling information is not received, the terminal controls at least one primary receiver or at least one primary transceiver to be in a sleep state.

In some embodiments, the scheduling information is used to schedule transmission resources. In the embodiments of the present disclosure, the terminal may send the power saving response signal to inform the access network device whether at least one primary receiver or at least one primary transceiver of the terminal is woken up, so that the access network device may schedule the transmission resource for the terminal. If the terminal determines that the scheduling information is not received, the terminal may determine that no scheduling information is sent at this time, and may control at least one primary receiver or at least one primary transceiver to be in a sleep state, thus saving energy consumption.

In some embodiments, if the terminal determines the scheduling information is not received after a second duration from a moment that the terminal sends the first number of power saving response signals, the terminal controls at least one primary receiver or at least one primary transceiver to be in a sleep state.

In some embodiments, the scheduling information is used to schedule transmission resources. In the embodiments of the present disclosure, the terminal may send the power saving response signal to inform the access network device whether at least one primary receiver or at least one primary transceiver of the terminal is woken up, so that the access network device may schedule the transmission resource for the terminal. If the terminal determines that the scheduling information is not received after a second duration that the terminal sends the first number of the power saving response signals, the terminal may determine that no scheduling information is sent at this time, and may control at least one primary receiver or at least one primary transceiver to be in a sleep state, thus saving energy consumption.

In some embodiments, if the power saving response signal is sent periodically, the terminal may directly send the power saving response signal more than one time until the scheduling information sent by the access network device is received.

In the embodiments of the present disclosure, the terminal may send the power saving response signal more than one time at more than one first time domain position. Since the terminal needs to receive the scheduling information to determine the transmission resource, the terminal may send the power saving response signal all the time before the terminal receives the scheduling information, until the scheduling information is received.

It should be noted that, in the embodiments of the present disclosure, it is described by using an example in which the terminal sends the power saving response signal. In another embodiment, the terminal may further control the primary receiver or the primary transceiver of the terminal to be in a sleep state.

In the embodiments of the present disclosure, the terminal determines, within a third duration that the terminal sends the power saving response signal, that the scheduling information is not received, and controls at least one primary receiver or at least one primary transceiver to be in a sleep state. In other words, within the third duration from a moment that the terminal sends the power saving response signal, the terminal waits to receive the scheduling information. If the terminal still does not receive the scheduling information within the third duration, it indicates that the access network device may not schedule the transmission resources, and the terminal does not need to keep at least one primary receiver or at least one primary transceiver of the terminal to be in a wake-up state, so that the terminal controls at least one primary receiver or at least one primary transceiver to be in a sleep state.

In some embodiments, the terminal may continuously send the power saving response signal at the first time domain position within the third duration. In addition, the manner of sending the power saving response signal may refer to the manner of sending the power saving response signal periodically in the foregoing embodiments.

In some embodiments, the third duration is a time absolute value. For example, the third duration is 3 ms, 4 ms, or another value. In some embodiments, the third duration is represented by using a time domain identifier. For example, the third duration is represented by a slot, or is represented by using a symbol.

In the solution provided in the embodiments of the present disclosure, the terminal may send the power saving response signal once or periodically, so that the terminal notifies the access network device of the state of at least one primary receiver or at least one primary transceiver of the terminal. Therefore, the access network device may schedule the transmission resource for the terminal, thus ensuring transmission reliability.

It should be noted that the foregoing embodiments may be split into a new embodiment, or may be combined with other embodiments into a new embodiment, which is not limited in the present disclosure.

FIG. 3 is a block diagram of an apparatus for time domain determination provided according to some embodiments of the present disclosure. Referring to FIG. 3, the apparatus includes a processing module 301.

The processing module 301 is configured to determine a first time domain position, where the first time domain position is used for the terminal to send a power saving response signal, and the power saving response signal is used to indicate whether at least one primary receiver or at least one primary transceiver of the terminal is woken up.

In some embodiments, referring to FIG. 4, the apparatus further includes a receiving module 302.

The receiving module 302 is configured to receive configuration information, where the configuration information is used to configure the first time domain position.

In some embodiments, the first time domain position is a time domain position where an uplink resource is present after an access network device sends a first power saving signal.

In some embodiments, the first time domain position is a time domain position where an uplink resource is present after a first duration from a moment that the access network device sends a first power saving signal.

In some embodiments, the first time domain position is a time domain position configured with the power saving response signal.

In some embodiments, the first time domain position is a time domain position configured with the power saving response signal after a first duration from a moment that the access network device sends a first power saving signal.

In some embodiments, the power saving response signal is sent once or periodically.

In some embodiments, the processing module 301 is further configured to:

determine a first number of first time domain positions based on an time domain offset.

The apparatus further includes: a sending module 303, configured to send the first number of power saving response signals based on the first number of first time domain positions.

In some embodiments, the processing module 301 is configured to: after sending the first number of power saving response signals, determine that scheduling information is not received, and control the at least one primary receiver or the at least one primary transceiver to be in a sleep state.

In some embodiments, the processing module 301 is configured to: after a second duration from a moment for sending the first number of power saving response signals, determine that scheduling information is not received, and control the at least one primary receiver or the at least one primary transceiver to be in a sleep state.

In some embodiments, the power saving response signal is periodically sent, and the sending module 303 is further configured to send the power saving response signal more than one time until receiving scheduling information sent by the access network device.

In some embodiments, the processing module 301 is configured to determine, within a third duration for sending the power saving response signal, that scheduling information is not received, and control the at least one primary receiver or the at least one primary transceiver to be in a sleep state.

In some embodiments, the sending module 303 is further configured to send the power saving response signal at the first time domain position within the third duration.

In some embodiments, referring to FIG. 4, the apparatus further includes a receiving module 302.

The receiving module 302 is configured to receive a first power saving signal, where the first power saving signal is used to wake up at least one primary receiver or at least one primary transceiver of the terminal.

In some embodiments, the receiving module 302 is further configured to receive a second power saving signal, where the second power saving signal is sent by the access network device in a case that the access network device determines that the power saving response signal is not received after a fourth duration.

In some embodiments, the first time domain position is a m-th time domain unit, and m is a positive integer.

It should be noted that, for the apparatus provided in the foregoing embodiment, when the functions of the apparatus are implemented, it is only described by taking the division of the foregoing functional modules as an example, and in an actual application, the foregoing function allocation may be completed by different functional modules according to needs. That is, the internal structure of the device may be divided into different functional modules to complete all or some of the functions described above. In addition, the apparatus provided in the foregoing embodiments and method embodiments belong to the same concept, and specific implementation processes for the apparatus may refer to the method embodiments, which is not described here again.

FIG. 5 is a block diagram of an apparatus for time domain determination provided according to some embodiments of the present disclosure. Referring to FIG. 5, the apparatus includes a processing module 501.

The processing module 501 is configured to determine a first time domain position, where the first time domain position is used for a terminal to send a power saving response signal, and the power saving response signal is used to indicate whether at least one primary receiver or at least one primary transceiver of the terminal is woken up.

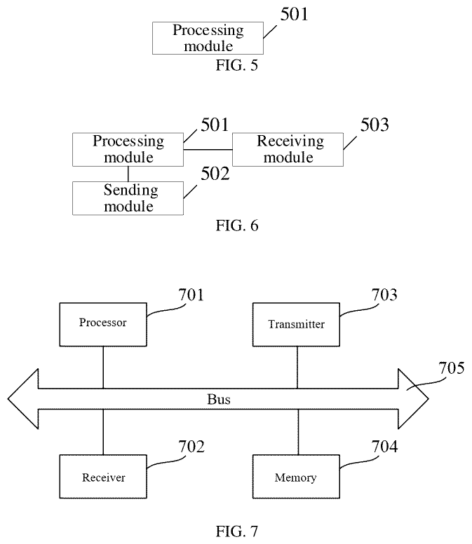

In some embodiments, referring to FIG. 6, the apparatus further includes a sending module 502.

The sending module 502 is configured to send configuration information, where the configuration information is used to configure the first time domain position.

In some embodiments, the first time domain position is a time domain position where an uplink resource is present after the access network device sends a first power saving signal.

In some embodiments, the first time domain position is a time domain position where an uplink resource is present after a first duration from a moment that the access network device sends a first power saving signal.

In some embodiments, the first time domain position is a time domain position configured with the power saving response signa.

In some embodiments, the first time domain position is a time domain position configured with the power saving response signal after a first duration from a moment that the access network device sends a first power saving signal.

In some embodiments, the power saving response signal is sent once or periodically.

In some embodiments, referring to FIG. 6, the apparatus further includes a receiving module 503, configured to receive a first number of power saving response signals based on the first number of first time domain positions, where the first number of first time domain positions are determined by the terminal based on a time domain offset.

In some embodiments, the power saving response signal is sent periodically. Referring to FIG. 6, the receiving module 503 is further configured to receive the power saving response signal more than one time.

In some embodiments, referring to FIG. 6, the receiving module 503 is further configured to receive the power saving response signal at a first time domain position within a third duration.

In some embodiments, the sending module 502 is further configured to send a first power saving signal, where the first power saving signal is used to wake up at least one primary receiver or at least one primary transceiver of the terminal.

In some embodiments, the sending module 502 is further configured to send a second power saving signal if it is determined that the power saving response signal is not received after the fourth duration.

In some embodiments, the first time domain position is a m-th time domain unit, and m is a positive integer.

It should be noted that, for the apparatus provided in the foregoing embodiment, when the functions of the apparatus are implemented, it is only described by taking the division of the foregoing functional modules as an example, and in an actual application, the foregoing function allocation may be completed by different functional modules according to needs. That is, the internal structure of the device may be divided into different functional modules to complete all or some of the functions described above. In addition, the apparatus provided in the foregoing embodiments and method embodiments belong to the same concept, and specific implementation processes for the apparatus may refer to the method embodiments, which is not described here again.

FIG. 7 is a schematic structural diagram of a communication device provided according to some embodiments of the present disclosure, where the communication device includes a processor 701, a receiver 702, a transmitter 703, a memory 704, and a bus 705.

The processor 701 includes one or more processing cores, and the processor 701 executes various functional applications and information processing by running a software program and a module.

The receiver 702 and the transmitter 703 may be implemented as a communication component, and the communication component may be a communication chip.

The memory 704 is connected to the processor 701 by using the bus 705.

The memory 704 may be configured to store at least one program code, and the processor 701 is configured to execute the at least one program code, to implement steps in the foregoing method embodiments.

In addition, the communication device may be a terminal or an access network device. The memory 704 may be implemented by any type of volatile or non-volatile storage device or a combination of them, including but not limited to: a magnetic disk or optical disk, an electrically erasable programmable read-only memory (EEPROM), an erasable programmable read-only memory (EPROM), a static time access memory (SRAM), a read-only memory (ROM), a magnetic memory, a flash memory, and a programmable read-only memory (PROM).

In some embodiments, there is further provided a computer-readable storage medium, where executable program code is stored in the readable storage medium, and the executable program code is loaded and executed by a processor to implement the method for time domain determination performed by the communication device provided in the foregoing method embodiments.

In some embodiments, there is provided a chip, where the chip includes a programmable logic circuit and/or a program instruction. When the chip runs on a terminal or an access network device, the chip is configured to implement the method for time domain determination provided according to the various method embodiments.

In some embodiments, there is provided a communication system, where the communication system includes a terminal and an access network device. The terminal is configured to implement the method for time domain determination as described above, and the access network device is configured to implement the method for time domain determination as described above.

In some embodiments, there is provided a computer program product. When the computer program product is executed by a processor of a terminal or an access network device, the computer program product is configured to implement the method for time domain determination provided in the foregoing method embodiments.

According to embodiments of the present disclosure, there is provided a method for time domain determination and an apparatus, to improve accuracy of receiving a power saving response signal by an access network device, and further to ensure communication reliability. the technical solution is as follows:

According to a first aspect of the present disclosure, there is provided a method for time domain determination, where the method is performed by a terminal, and the method includes:
determining a first time domain position, where the first time domain position is used for the terminal to send a power saving response signal, and the power saving response signal indicates whether at least one primary receiver or at least one primary transceiver of the terminal is woken up.

According to a second aspect of the present disclosure, there is provided a method for time domain determination, where the method is performed by an access network device, and the method includes:
determining a first time domain position, where the first time domain position is used for a terminal to send a power saving response signal, and the power saving response signal indicates whether at least one primary receiver or at least one primary transceiver of the terminal is woken up.

According to another aspect of the present disclosure, there is provided an apparatus for time domain determination, including:
a processing module, configured to determine a first time domain position, where the first time domain position is used for a terminal to send a power saving response signal, and the power saving response signal indicates whether at least one primary receiver or at least one primary transceiver of the terminal is woken up.

According to another aspect of the present disclosure, there is provided an apparatus for time domain determination, including:

a processing module, configured to determine a first time domain position, where the first time domain position is used for a terminal to send a power saving response signal, and the power saving response signal indicates whether at least one primary receiver or at least one primary transceiver of the terminal is woken up.

According to another aspect of the present disclosure, there is provided a terminal, including: a processor; a transceiver, connected to the processor; and a memory, configured to store an executable instruction for the processor, where the processor is configured to load and execute the executable instruction to implement the method for time domain determination according to the first aspect.

According to another aspect of the present disclosure, there is provided an access network device, including: a processor; a transceiver, connected to the processor; and a memory, configured to store an executable instruction for the processor, where the processor is configured to load and execute the executable instruction to implement the method for time domain determination according to the second aspect.

According to another aspect of the present disclosure, there is provided a communication system including a terminal and an access network device, where the terminal is configured to implement the method for time domain determination according to the first aspect, and the access network device is configured to implement the method for time domain determination according to the second aspect.

According to another aspect of the present disclosure, there is provided a non-transitory computer-readable storage medium, where executable program code is stored in the non-transitory computer-readable storage medium, and the executable program code is loaded and executed by a processor to implement the method for time domain determination according to the above aspects.

According to another aspect of the present disclosure, there is provided a chip, where the chip includes a programmable logic circuit and/or a program instruction, and when the chip runs on a terminal or an access network device, the chip is configured to implement the method for time domain determination according to the above aspects.

According to another aspect of the present disclosure, there is provided a computer program product, and when the computer program product is executed by a processor of a terminal or an access network device, the computer program product is configured to implement the method for time domain determination in the above aspects.

The present disclosure provides a solution for determining a fixed time domain position for sending a power saving response signal by a terminal, to ensure that the terminal sends the power saving response signal at the fixed time domain position, and the access network device receives the power saving response signal at the fixed time domain position, thus improving accuracy of receiving the power saving response signal by the access network device, and ensuring communication reliability.

Those of ordinary skill in the art may understand that all or some of the steps in the foregoing embodiments may be completed by hardware, or may be completed by instructing related hardware through a program, where the program may be stored in a computer-readable storage medium, and the foregoing storage medium may be a read-only memory, a magnetic disk, an optical disk, or the like.

The foregoing descriptions are merely optional embodiments of the present disclosure, which is not intended to limit the present disclosure. Any modification, equivalent replacement, or improvement made without departing from the spirit and principle of the present disclosure shall fall within the protection scope of the present disclosure.

1. A method for time domain determination, performed by a terminal, and comprising:
determining a first time domain position, wherein a power saving response signal is sent by the terminal at the first time domain position, and the power saving response signal indicates whether at least one primary receiver or at least one primary transceiver of the terminal is woken up.

2. The method according to claim 1, further comprising at least one of:
receiving configuration information configure the first time domain position;
receiving a first power saving signal to wake up the at least one primary receiver or the at least one primary transceiver of the terminal; or
receiving a second power saving signal sent by an access network device in response to the access network device determining that the power saving response signal is not received after a fourth duration;
wherein the first time domain position is a m-th time domain unit, and m is a positive integer.

3. The method according to claim 1, wherein the first time domain position comprises one of:
a time domain position at which an uplink resource is present after an access network device sends a first power saving signal;
a time domain position at which an uplink resource is present after a first duration from a moment that the access network device sends a first power saving signal;
a time domain position configured with the power saving response signal; or
a time domain position configured with the power saving response signal after a first duration from a moment that the access network device sends a first power saving signal.

4. The method according to claim 1, wherein the power saving response signal is transmitted once or periodically.

5. The method according to claim 4, wherein determining the first time domain position comprises:
determining a first number of first time domain positions based on a time domain offset;
wherein the method further comprises:
sending the first number of power saving response signals based on the first number of first time domain positions.

6. The method according to claim 5, further comprising:
after sending the first number of power saving response signals, in response to determining that scheduling information is not received, controlling the at least one primary receiver or the at least one primary transceiver to be in a sleep state.

7. The method according to claim 5, further comprising:
after a second duration from a moment for sending the first number of power saving response signals, in response to determining that scheduling information is not received, controlling the at least one primary receiver or the at least one primary transceiver to be in a sleep state.

8. The method according to claim 4, wherein the power saving response signal is sent periodically, and the method further comprises:
sending the power saving response signal more than one time until receiving scheduling information sent by an access network device.

9. The method according to claim 1, further comprising:
determining that scheduling information is not received within a third duration from a moment for sending the power saving response signal; and
controlling the at least one primary receiver or the at least one primary transceiver to be in a sleep state.

10. The method according to claim 9, further comprising:
sending the power saving response signal at the first time domain position within the third duration.

11.-13. (canceled)

14. A method for time domain determination, performed by an access network device, and comprising:
determining a first time domain position, wherein a power saving response signal is sent by a terminal at the first time domain position, and the power saving response signal indicates whether at least one primary receiver or at least one primary transceiver of the terminal is woken up.

15. The method according to claim 14, further comprising at least one of:
sending configuration information, to configure the first time domain position;
receiving the power saving response signal at the first time domain position within a third duration;
sending a first power saving signal to wake up the at least one primary receiver or the at least one primary transceiver of the terminal; or sending a second power saving signal in a case of determining that the power saving response signal is not received after a fourth duration;
wherein the first time domain position is a m-th time domain unit, and m is a positive integer.

16. The method according to claim 14, wherein the first time domain position comprises one of:
a time domain position at which an uplink resource is present after the access network device sends a first power saving signal; or
a time domain position at which an uplink resource is present after a first duration from a moment that the access network device sends a first power saving signal; or
a time domain position configured with the power saving response signal; or
a time domain position configured with the power saving response signal after a first duration from a moment that the access network device sends a first power saving signal.

17. The method according to claim 14, wherein the power saving response signal is transmitted once or periodically.

18. The method according to claim 17, further comprising:
receiving a first number of power saving response signals based on the first number of first time domain positions, wherein the first number of first time domain positions are determined by the terminal based on a time domain offset.

19. The method according to claim 17, wherein the power saving response signal is sent periodically, and the method further comprises:
receiving the power saving response signal more than one time.

20.-25. (canceled)

26. A terminal, comprising:
a processor; and
a transceiver, connected to the processor;
wherein the processor is configured to: instruction
determine a first time domain position, wherein a power saving response signal is sent by the terminal at the first time domain position, and the power saving response signal indicates whether at least one primary receiver or at least one primary transceiver of the terminal is woken up.

27. An access network device, comprising:
a processor; and
a transceiver, connected to the processor;
wherein the processor is configured to to implement the method according to claim 14.

28. (canceled)

29. A non-transitory computer-readable storage medium, storing executable program code that, and when executed by a processor, causes the processor to implement the method according to claim 1.

23.

30. A non-transitory computer-readable storage medium storing executable program code that, when executed by a processor, causes the processor to implement the method according to claim 14.
